(19) United States
(12) Patent Application Publication
(10) Pub. No.: US 2019/0382252 A1
(43) Pub. Date: Dec. 19, 2019

(54) Lifting Device, Such as a Forklift Truck and Pallet Truck, Provided with a Sensor System, and Method Therefor

(71) Applicant: Meijer Holding B.V., Sint Jacobiparochie (NL)

(72) Inventors: Hendrik Meijer, Sint Jacobiparochie (NL); Folkert De Graaf, Leeuwarden (NL)

(21) Appl. No.: 16/480,449

(22) PCT Filed: Jan. 24, 2018
(86) PCT No.: PCT/NL2018/050052

§ 371 Date: Jul. 24, 2019

(30) Foreign Application Priority Data
Jan. 24, 2017 (NL) 2018218

(51) Int. Cl. B66F 9/075; B66F 9/12; B66F 9/24

(52) U.S. Cl. CPC B66F 9/0755; B66F 9/24; B66F 9/122

(57) ABSTRACT

The present invention relates to a lifting device, such as a forklift truck or pallet truck, provided with a sensor system and method therefor. The lifting device includes: a frame; a fork system with a number of forks, connected to the frame; controller configured to detect an undesired bending and/or length of a fork; and a sensor system arranged in or on the fork system and operatively connected to the controller. The sensor system is configured to provide a bending measurement and/or a length measurement of at least one of the forks of the fork system to the controller.

The invention relates to a lifting device, particularly a forklift truck or pallet truck, and more particularly a forklift truck provided with a sensor system.

Lifting devices are known in practice in the form of inter alia forklift trucks and pallet trucks. Forklift trucks known in practice can here be provided with length-adjustable forks, wherein the forks can be provided for the purpose of extending thereof with a drive. A manually length-adjustable fork for a forklift truck is for instance described in NL 2011022. A pallet truck with outward slidable forks is for instance described in NL 2004095.

Such conventional lifting devices have the drawback that they are not adapted to the cargo to be transported or handled. There can thus for instance be an undesired measure of bending of the forks relative to a heavy cargo. This can occur particularly in lifting devices having a length-adjustable fork system. This is because the moment arm is changed here, whereby a significant bending may occur of the forks on which the cargo is arranged. This may result in dangerous situations, wherein cargo may fall or slide off the fork. This is particularly dangerous when work is for instance carried out at great height using a forklift truck, for instance during placing or taking away of goods into or from a warehouse rack.

The present invention has for its object to provide a lifting device with which the above stated problems are obviated or at least reduced.

This objective is achieved with the lifting device according to the invention, such as a forklift truck or pallet truck, wherein the lifting device comprises:

a frame;

a fork system with a number of forks, connected to the frame;

a controller configured to detect an undesired bending and/or length of a fork; and

a sensor system arranged in or on the fork system and operatively connected to the controller, wherein the sensor system is configured to provide a bending measurement and/or a length measurement of at least one of the forks of the fork system to the controller.

The lifting device is for instance a forklift truck or pallet truck. In the most preferred embodiments according to the invention the lifting device is a forklift truck with an extendable fork system. By adjusting the length of the forks this length can be adapted to the cargo to be displaced, for instance for one of the different standard types of pallet. Damage during manoeuvring and picking up and/or setting down of the cargo is hereby avoided as far as possible in that the forks do not extend unnecessarily beyond the cargo.

The sensor system according to the invention is configured to measure a bending and/or a length of at least one of the forks of the lifting device. The length measurement is particularly relevant in the case of a lifting device with an extendable fork. The bending is in principle interesting for any type of lifting device, particularly for forklift trucks which have to set down or take away goods at a certain height. The sensor system is provided here with one or more sensors suitable for performing the desired measurements, preferably for measuring both the length and the bending.

In a currently preferred embodiment the sensor system is provided with an inclinometer and/or strain gauges for providing a bending measurement of at least one of the forks. The sensor system is here preferably substantially mounted on the extendable part of the forks, optionally in combination with a reference sensor or reference point on the fixed part of the lifting device or a fixed part of the fork. It is noted that when a heavy cargo is expected, the forks can optionally be tilted, i.e. placed at an angle relative to the horizontal, so as to pre-empt the expected bending. The sensors then detect whether the expectation is correct or whether a further (additional) correction is required.

In an advantageous embodiment of the invention the sensor system comprises a cable transducer, laser, ultrasonic sensor, flow sensor or similar sensor for providing the length measurement of at least one of the forks. It has been found that a length measurement can be performed in effective manner with this sensor type. It will be apparent that the use of other types of sensor is possible. This length measurement is preferably performed in embodiments of the lifting device having an extendable fork. The above stated risk of damage is hereby prevented.

According to the invention, the sensor system is operatively connected to the controller. Configuring the controller to detect undesired bending and/or an undesired length of a fork enables a potentially dangerous situation to be detected in timely manner The controller can then generate a signal to the driver and/or intervene itself by adjusting the lifting device and/or blocking all or determined actions with the lifting device, such as lifting of a cargo in the case of a potentially dangerous situation. Such potentially dangerous situations for instance occur if the bending is greater than a threshold value. This threshold value depends on the type of lifting device and preferably depends on the current length of the fork in the case of an extendable fork.

The length measurement is preferably combined with a bending measurement and preferably likewise with a weight measurement in order to determine the overall load for the forks, including for instance occurring forces and moments. More information about the actual load is hereby obtained, whereby unsafe situations can be avoided still further. In addition to or as an alternative to one or more of the above stated sensors, use can here be made of a further alternative sensor. An example of such an alternative sensor which can additionally be applied is for instance a load cell with which the weight of the cargo on the fork can be measured.

In a further preferred embodiment according to the invention the sensor system further comprises a pointing system configured to orient the forks of the fork system.

Providing a pointing system enables the position of the forks, particularly the foremost point or nose element thereof, to be made visible to the driver of the lifting device. Such a pointing system can be used in particularly advantageous manner in a forklift truck with length-adjustable forks. The risk of doing damage to walls or other goods with the lifting device according to the invention is hereby further reduced. In a currently preferred embodiment the pointing system is provided with a laser for indicating the position of the nose element of the fork.

In an advantageous embodiment according to the invention the sensor system further comprises a transmitter and/or transmitter-receiver.

By providing the sensor system with a transmitter and/or transmitter-receiver performed measurements can be transmitted to for instance the controller. A wireless sensor system can hereby be applied. This is particularly advantageous in the case of length-adjustable forks, so that no complex wiring is required. The wireless system further has the advantage that cables need not be concealed in the forks, which requires relatively complex and expensive operations, for instance the provision of an additional channel for the cabling. By providing a receiver the sensor system can also receive information from for instance a controller. The controller can hereby request that a measurement be performed.

It is further possible to have the sensor system with the transmitter and/or transmitter-receiver communicate with an external system, for instance a planning system, stock control system, maintenance system and/or other ERP system. In such an embodiment of the invention the lifting device is hereby further integrated with relevant operational processes. It is thus for instance possible to couple the use of a lifting device according to the invention to the cargo, and thereby for instance specifically allocate the cost of the use of the forklift truck. Settings of for instance the lifting device, including length of the length-adjustable forks and/or the tilt angle of the fork system, can also be adjusted to the cargo, for instance by reading a barcode or QR code of the cargo. For this reason such a reader is preferably provided on the lifting device and/or the user is equipped therewith. This further increases the safety of working with the lifting device according to the invention. It is also possible to generate an authorization signal from such an ERP system to the lifting device for picking up and/or displacing the goods. This increases the safety of and control over the logistical processing in for instance a distribution centre or other warehouse.

In a further advantageous embodiment according to the invention the lifting device is further provided with a tilting system for correcting the position of the forks in accordance with a bending measured with the sensor system.

By providing a tilting system an undesired degree of bending can if desired be compensated by tilting the forks, as already elucidated above. Such a tilting system can be present in usual manner on the lifting device, particularly on the forklift truck, and can for instance be provided on the so-called fork back. Such a tilting system on the fork back is preferably embodied as separate module in order to thereby have the ability to be applied in universal manner for different types of fork and/or different types of lifting device. Use is for instance made here of a preferably compact hydraulic or electric cylinder with a limited incorporating structure which is integrated with the fork back, particularly in suspension claws or fork back. In a currently preferred embodiment the tilting system is operatively connected to the controller which is preferably arranged in a cab of a forklift truck. A driver can hereby control the tilting system in effective manner According to the invention, it is also possible that the controller controls the tilting system in automatic manner on the basis of the performed measurements.

As part of an ERP system, or in addition thereto, measured data can also be stored in a data logger or other data storage system. This makes data available for determining for instance maintenance intervals, degree of use of so-called attachments, and other logistical information.

In the case of a wireless system the sensor system is provided with an accumulator, for instance a battery. A combination with an external system also enables tracking of the status of the accumulator, if desired, such that the accumulator can be exchanged and/or charged in timely manner This results in a robust system.

In a currently preferred embodiment the controller for the tilting system is embodied as a (semi-)separate bending controller which sets said tilting system in automatic manner on the basis of information received from the sensor system.

In similar manner an extension controller can additionally also be provided, optionally as part of the controller, configured to adjust the length of the extending forks. The length of the forks can hereby be adjusted in automatic manner to the goods and/or pallets to be handled.

The extension controller and/or bending controller are preferably combined with a reader configured to read information about for instance dimensions and/or weight of the cargo to be handled. This enables preventive adjustment of a setting of the lifting device to the cargo to be handled. This provides a preventative effect, which further reduces the risk of unsafe situations.

In an advantageous embodiment according to the invention the sensor system comprises a sensor module provided with a flow meter configured to measure the flow, and an angle measuring device.

Providing a sensor module makes it possible to provide information to the controller in effective manner In the case of the sensor module such information is preferably in particular information about the quantity of hydraulic fluid, such as an oil, which is driven to an element, such as a cylinder of an extending fork, in a period of time. This enables a measurement of the position of the extending fork. Preferably also provided in such an embodiment is an angle measuring device, with which it is possible to measure an angle with for instance a ground surface. More particularly, it is hereby possible to determine the angle of for instance extending forks with the ground surface and/or a horizontal plane.

The sensor module is for instance able to send combined data of the flow and angular displacement to a controller or other system. It is then possible to adjust settings of for instance a forklift truck. It is possible here to compensate for bending when a cargo is slid out or slid in further on an extending fork using a (hydraulic) cylinder.

The sensor module is optionally provided with its own accumulator or battery. Alternatively, the sensor module can be wired. An optional accumulator is preferably rechargeable, for instance with an electrical connection, by making use of a hydraulic oil flow and/or fork movement using a dynamo, and/or a kinetic charging system on the basis of movement of the lifting device. Power cables are hereby avoided, and a relatively compact and simple construction can suffice. If desired, it is also possible to take the power required for the measurements directly from the oil flow. Communication can take place in wireless and/or wired manner In addition, it is possible to expand the sensor module with other sensors. An example hereof is an accelerometer with which accelerations can be measured, for instance detection of unsafe movements. In addition, the sensor module can be combined with either one or more identical sensor modules or one or more PCBs as are used in the sensor module in order to determine for instance a difference in flow, angle or acceleration. According to the invention, the sensor module can optionally be applied in conventional lifting devices, such as a forklift truck. It is however also possible to apply the sensor module as a separate unit in other systems, for instance a hydraulic angular adjustment of a mast forklift truck, hydraulic fork adjusters and/or sideshift of a forklift truck, hydraulically extendable crane arms, digging and/or hoisting devices.

In a further advantageous embodiment according to the invention the fork system is provided with a recess adapted to the sensor system.

By providing the sensor system in a recess of the fork system a compact lifting device is provided. A robust housing is hereby further provided for the sensor system, whereby this is positioned safely in respect of damage. An additional advantage of arranging a sensor system in a recess in the fork is that contamination has less chance of affecting the measurement.

The recess is preferably arranged in or under an exchangeable wear pad, which is also understood to mean a wear plate, of the fork system. A good shielding of the sensor system is hereby obtained. In a currently preferred embodiment the recess is provided in the movable sleeve of an adjustable fork part of an extending fork. Alternatively, the recess can also be provided in a different part.

Although the sensor system for the lifting device according to the invention is advantageously applied in a forklift truck with length-adjustable forks, the sensor system can also be applied in other lifting devices, including a pallet truck or forklift truck with fixed forks. At least some of the stated advantages are hereby achieved.

The invention also relates to a method for providing measurement information about a fork of a fork system of a lifting device, such as a forklift truck or pallet truck, comprising the steps of:
providing a lifting device according to any of the embodiments of the invention;
determining the length and/or bending of at least one of the forks with the sensor system; and
reporting the determined length and/or bending.

Such a method provides the same effects and advantages as described for the lifting device. The method provides in particular a safe work situation in which the chance of unsafe situations is reduced.

An additional advantage of applying a sensor system is that the obtained measurement information can be used by external systems, which enables diverse logistical advantages as well as planning advantages and effective maintenance.

Further advantages, features and details of the invention are elucidated on the basis of preferred embodiments thereof, wherein reference is made to the accompanying drawings, in which:

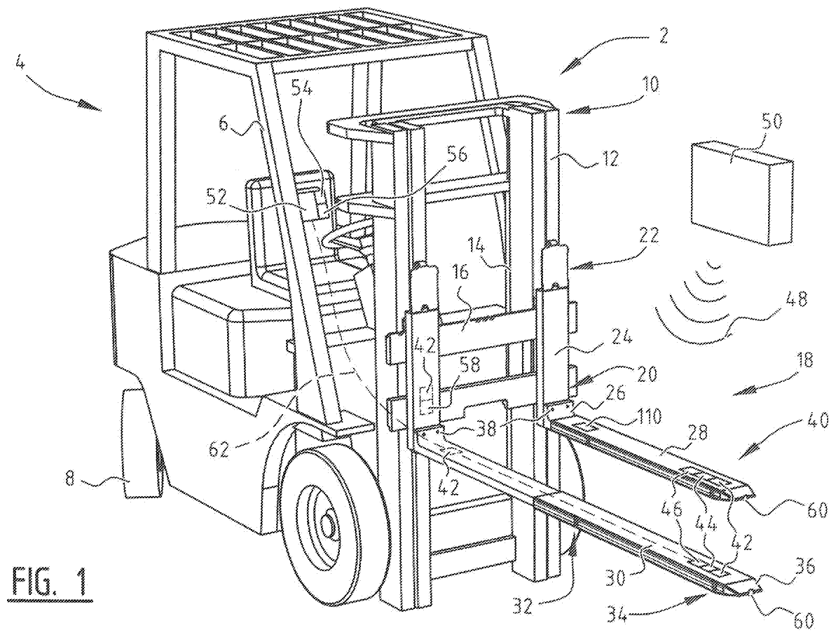

FIG. 1 shows a view of a forklift truck with extendable forks and modular inner fork provided with a sensor system according to the invention;

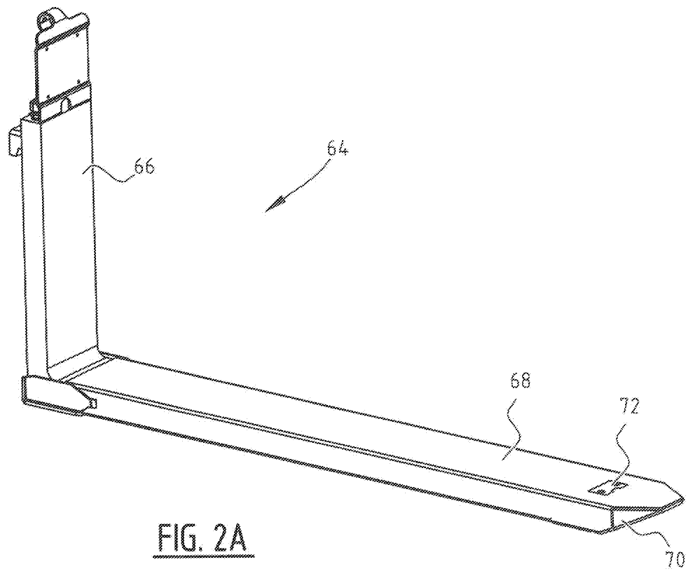

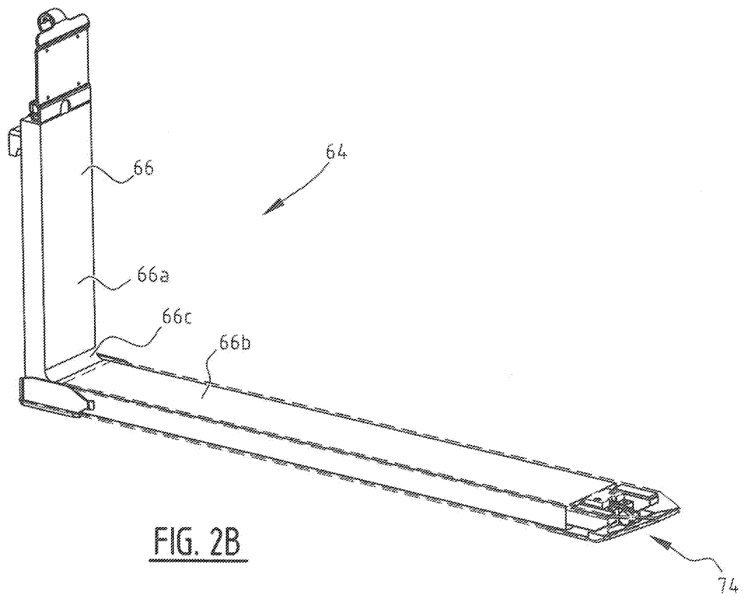

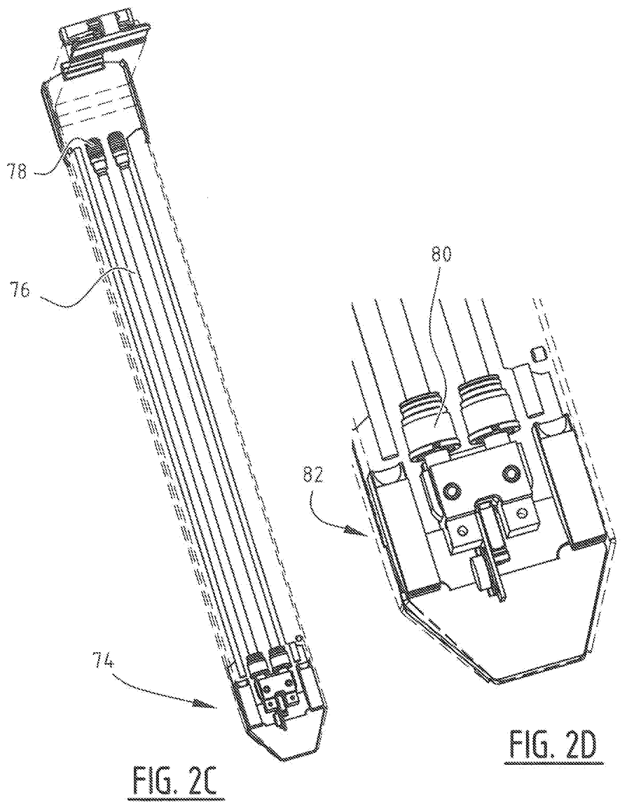

FIGS. 2A-D show views of an alternative extendable fork and conventional inner fork in one piece for the lifting device according to the invention;

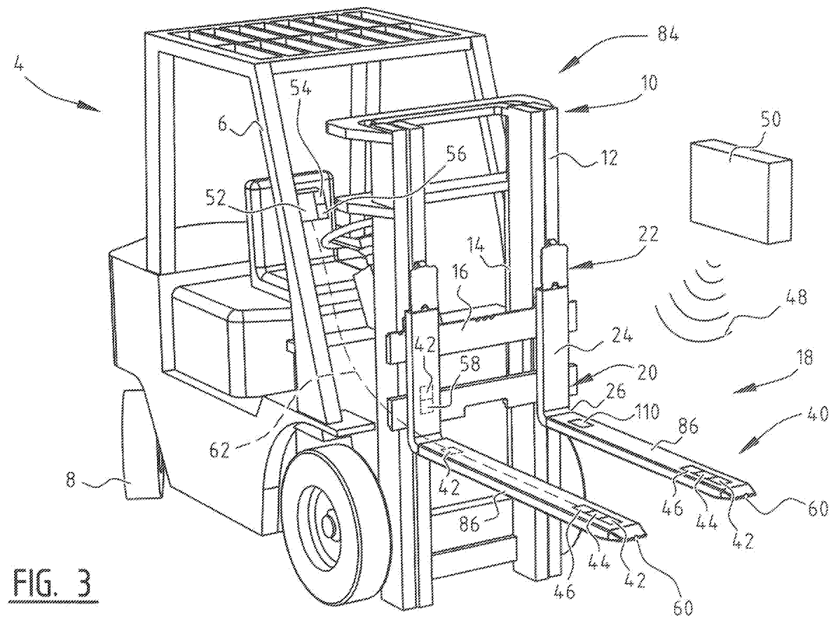

FIG. 3 shows a view of a forklift truck with conventional (non-extendable) forks provided with the sensor system according to the invention;

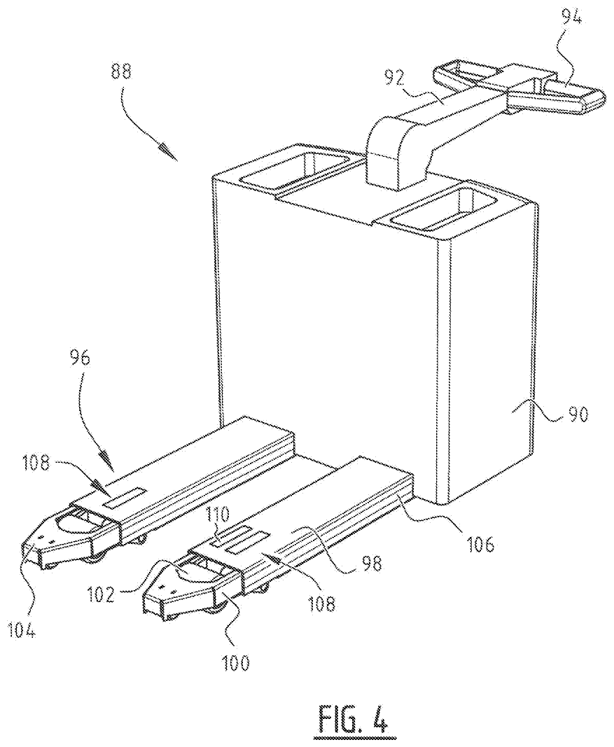

FIG. 4 shows a view of a pallet truck provided with the sensor system according to the invention; and

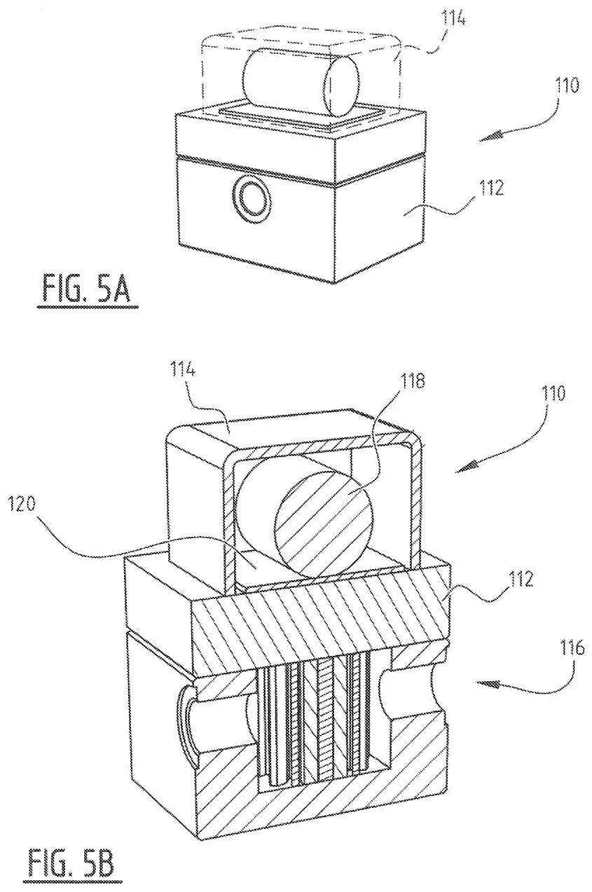

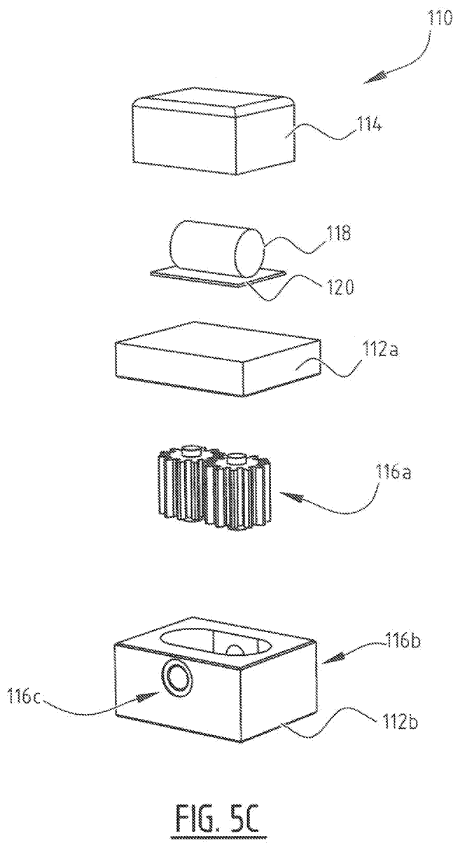

FIGS. 5A-C show a sensor module usable in for instance the forklift truck and/or pallet truck of FIGS. 1-4.

Forklift truck 2 (FIG. 1) is provided with cab 4, frame 6 and a number of wheels 8. Mast construction 12 is provided on front side 10 of forklift truck 2. In the shown embodiment construction 12 is provided with two guides 14 in which or on which fork board 16 is arranged. Two forks 18 according to the invention are arranged on fork board or connecting element 16.

Fork 18 consists of a fixed fork part 20. Fixed fork part 20 is provided at a first outer end with a number of mounting points or mounting elements 22 for mounting on element 16. Via a first part 24 oriented substantially vertically during use and bend 26 the fixed fork part 20 transposes into a second part 28 which is substantially horizontal during use. In the shown embodiment second fork part 28 connects to the adjustable fork part 30 which is slidable thereover and functions as outer fork. In the shown embodiment adjustable fork part 30 is provided with first recess 32 for a mode of use with a lengthened fork, and second recess 34 for a mode of use with a shortened fork. A plurality of intermediate recesses are optionally possible for the purpose of thereby realizing further adjustable fork lengths. It is also possible to provide such positions in other ways. Nose element 36 is situated on the front side, i.e. at the free outer end of fork 18. Nose element 36 is inserted under the goods to be picked up.

In the shown embodiment fixed fork part 20 is provided from two separate parts 24, 28. Close to corner 26 parts 24, 28 are connected by means of connecting element 38, in the shown embodiment a bolt connection. It will be apparent that other connecting means can also be applied. In the shown embodiment a thickened portion is arranged on adjustable outer fork 30 at the position of corner 26 and in the assembled situation. It will be apparent that such a modular system for fixed fork part 20 can in principle be applied to any type of outer fork 30. The combination of outer fork part 30 with a profiled sleeve profile and the modular fixed fork part 20 intensifies the advantages of an application-specific dimensioning of forks 18, which can be manufactured in cost-effective manner by reducing relatively complex production steps and/or increasing the flexibility.

In the shown embodiment sensor system 40 is provided in extendable fork part 30. Sensor system 40 comprises here one or more sensors in sensor part 42, including one or more of an inclinometer, strain gauges, cable transducer, laser, ultrasonic sensor, flow sensor. It will be apparent here that sensor system 40 can be arranged at other locations and distributed over multiple locations. Flow sensor 42 will thus preferably be arranged in the hydraulic system close to fork board 16, and strain gauges will preferably be arranged in or on vertical part 24. Transmitter-receiver 44 and power supply system 46, for instance embodied as an accumulator or battery, are also provided. Transmitter-receiver 44 communicates via signals 48 with external control system 50, for instance an ERP system. Arranged in cab 4 in the shown embodiment is a control box or interface 52 which is provided in the shown embodiment with bending controller 54 and extension controller 56. Also provided in the shown embodiment is additional sensor blocker 58 for an additional sensor and/or reference point which is operatively connected to the other parts of sensor system 40. In the shown embodiment forklift truck 2 is further provided with laser pointer 60 in or close to nose element 36. Laser pointer 60 is preferably integrated in sensor system 40. Although sensor system 40 operates wirelessly in the shown embodiment, a channel 62 can optionally be provided, for instance with a connecting wire as communication cable between sensor system 40 and control box 52.

Alternative fork 64 (FIGS. 2A-D) is provided with a fixed fork part 66 and extendable fork part 68 on which nose element 70 is provided. Recess 72 is also arranged, optionally with a cover plate. Fixed fork part 66 is here provided from a vertical part 66a, a substantially horizontal part 66b and a connecting part 66c. Such a fixed fork part 66 is for instance a conventional inner fork. For the extension use is made of drive 74 comprising extension parts 76 with hydraulic piston 78, cylinder head 80 and connecting module 82, whereby a connection to the hydraulic system of forklift truck 4 can for instance be provided. A relative movement can hereby be provided in known manner If desired, it is also possible to provide a manual system in similar manner as described in NL 2011022.

In an alternative embodiment, sensor system 40 can be applied in forklift truck 84 (FIG. 3) provided with fixed forks 86. The operation of forklift truck 84 is similar to the operation of forklift truck 2 as described above. It is further possible to apply sensor system 108 in pallet truck 88 (FIG. 4). In such an alternative application pallet truck 88 is provided with housing 90 on which arm 92 with handle 94 is provided on a side for the purpose of displacing pallet truck 88. Goods are placed on fork system 96, which has a fixed outer profile part 98 and extendable part 100 which is provided with support wheel 102. Support wheel 102 is situated close to or in nose 104. In the shown embodiment outer sleeve 98 is provided with a profile 106. It will be apparent that other embodiments are also possible according to the invention.

When goods have to be displaced with lifting device 2, 84, 88, these goods are placed on forks thereof. Information about the length of the forks and/or the bending caused by the goods is transmitted to controller 52 and/or external control system 50 using sensor system 40, 108. If desired, settings of forklift truck 2, 84 or pallet truck 88 are adjusted on the basis of the information obtained with sensor system 40, 108. This allows a user or forklift truck driver to decide to perform corrections, for instance to the tilt angle, him or herself. If desired, this can also be performed in automatic manner. The same applies to the setting of the length of the forks in the case of a length-adjustable fork as shown for forklift truck 2 (FIG. 1).

External system 50 makes it possible to plan maintenance, to monitor power supply system 46 and to recharge or exchange in timely manner The logistical handling of the goods can also be better tracked, and data about the goods to be displaced can if desired be used by controller 52 for the purpose of setting forklift truck 2, 84 or pallet truck 88.

Sensor module 110 can be applied in forklift trucks (FIGS. 1 and 3), pallet trucks (FIG. 4), and optionally in other devices. Sensor module 110 (FIGS. 5A-C) comprises housing 112 and cover 114. Housing 112 is provided with housing part 112a and cover 112b. In the shown embodiment flow meter 116 is provided, in the shown version a gear wheel flow meter, with gear wheels 116a, housing 116b, flow path 116c. In the shown embodiment accumulator 118 and PCB 120 are provided under cover 114. The various components are mutually connected and, where necessary, provided with seals. In the shown embodiment PCB 120 is provided with a transmitter/receiver for the purpose of enabling wireless communication with a controller.

The present invention is by no means limited to the above described preferred embodiments thereof. The rights sought are defined by the following claims, within the scope of which many modifications can be envisaged.

1. A lifting device, such as a forklift truck or pallet truck, comprising:
a frame;
a fork system with a number of forks, connected to the frame;
a controller configured to detect an undesired bending and/or length of a fork; and
a sensor system arranged in or on the fork system and operatively connected to the controller, wherein the sensor system is configured to provide a bending measurement and/or a length measurement of at least one of the forks of the fork system to the controller.

2. The lifting device as claimed in claim 1, wherein the sensor system comprises one or more of an inclinometer and strain gauges for providing the bending measurement of at least one of the forks.

3. The lifting device as claimed in claim 1, wherein the sensor system comprises one or more of a cable transducer, laser, ultrasonic sensor, flow sensor for providing the length measurement of at least one of the forks.

4. The lifting device as claimed in claim 1, wherein the sensor system further comprises a pointing system configured to orient the forks of the fork system.

5. The lifting device as claimed in claim 1, wherein the sensor system further comprises a transmitter and/or transmitter-receiver.

6. The lifting device as claimed in claim 1, wherein the lifting device further comprises a tilting system for correcting the position of the forks in accordance with a bending measured with the sensor system.

7. The lifting device as claimed in claim 1, wherein the forklift truck is provided with a bending controller configured to control the tilting system in automatic manner on the basis of information received from the sensor system.

8. The lifting device as claimed in claim 1, wherein the fork system is provided with a number of extending forks.

9. The lifting device as claimed in claim 1, further comprising an extension controller configured to adjust the length of the extending forks.

10. The lifting device as claimed in claim 1, further comprising a reader configured to read information about dimensions of the cargo to be handled.

11. The lifting device as claimed in claim 1, wherein the sensor system comprises a sensor module provided with a flow meter configured to measure the flow, and an angle measuring device.

12. The lifting device as claimed in claim 1, wherein the fork system is provided with a recess adapted to the sensor system.

13. The lifting device as claimed in claim 1, wherein the recess is arranged in or under an exchangeable wear pad of the fork system.

14. The lifting device as claimed in claim 1, wherein the sensor system is provided with an accumulator.

15. A method for providing measurement information about a fork of a fork system of a lifting device, such as a forklift truck or pallet truck, comprising the steps of:
providing a lifting device as claimed in claim 1;
determining a length and/or bending of at least one of the forks with the sensor system; and
reporting the determined length and/or bending.

16. A lifting device, such as a forklift truck or pallet truck, comprising:
a frame;
a fork system with a number of forks, connected to the frame;
a controller configured to detect an undesired bending and length of a fork; and
a sensor system arranged in or on the fork system and operatively connected to the controller, wherein the sensor system is configured to provide a bending measurement and a length measurement of at least one of the forks of the fork system to the controller.

17. The lifting device according to claim 16, wherein the lifting device further comprises a tilting system for correcting the position of the forks in accordance with a bending measured with the sensor system.

18. The lifting device according to claim 16, further comprising a reader configured to read information about dimensions of the cargo to be handled.

19. The lifting device according to claim 16, wherein the fork system is provided with a recess adapted to the sensor system, and wherein the recess is arranged in or under an exchangeable wear pad of the fork system.

20. The lifting device according to claim 16, wherein the sensor system comprises a sensor module provided with a flow meter configured to measure the flow, and an angle measuring device.
